(19) United States
(12) Patent Application Publication
(10) Pub. No.: US 2022/0009032 A1
(43) Pub. Date: Jan. 13, 2022

(54) LASER MACHINING DEVICE

(71) Applicant: HAMAMATSU PHOTONICS K.K., Hamamatsu-shi, Shizuoka (JP)

(72) Inventors: Takeshi SAKAMOTO, Hamamatsu-shi, Shizuoka (JP); Junji OKUMA, Hamamatsu-shi, Shizuoka (JP)

(73) Assignee: HAMAMATSU PHOTONICS K.K., Hamamatsu-shi, Shizuoka (JP)

(21) Appl. No.: 17/288,601

(22) PCT Filed: Oct. 30, 2019
(86) PCT No.: PCT/JP2019/042629

§ 371 Date: Apr. 26, 2021

(30) Foreign Application Priority Data
Oct. 30, 2018 (JP) 2018-203672

(51) Int. Cl. B23K 26/10; B23K 37/047; B23K 26/08; B23K 26/06

(52) U.S. Cl. CPC B23K 26/10; B23K 37/047; B23K 26/0643; B23K 26/0823; B23K 26/0853

(57) ABSTRACT

A laser processing apparatus includes: a support portion configured to move along a first direction; a first moving portion configured to move along a second direction orthogonal to the first direction; a first attachment portion configured to move along a third direction orthogonal to the first direction and the second direction; a first laser processing head attached to the first attachment portion; a light source unit; and a first mirror attached to the first moving portion. The first laser processing head includes a first entrance portion and a first condensing portion. The light source unit includes a first emission portion. The first mirror is attached to the first moving portion to face the first emission portion in the second direction and face the first entrance portion in the third direction.

### TECHNICAL FIELD

The present disclosure relates to a laser processing apparatus.

### BACKGROUND ART

Patent Literature 1 describes a laser processing apparatus including a holding mechanism for holding a workpiece and a laser irradiation mechanism for irradiating the workpiece held by the holding mechanism with a laser light. In the laser processing apparatus described in Patent Literature 1, the laser irradiation mechanism including a condensing lens is fixed to a base, and the holding mechanism moves the workpiece in a direction orthogonal to the optical axis of the condensing lens.

### CITATION LIST

### Patent Literature

Patent Literature 1: Japanese Patent No. 5456510

### SUMMARY OF INVENTION

### Technical Problem

In the laser processing apparatus described above, a configuration in which a condensing lens moves in a direction along the optical axis of the condensing lens may be suitable, for the sake of application to various types of processing. However, in the laser processing apparatus described in Patent Literature 1, the laser irradiation mechanism is formed with configurations, on the optical path of the laser light from a laser oscillator to the condensing lens, arranged in the housing, and thus the condensing lens is difficult to move in the direction orthogonal to the optical axis of the condensing lens.

It is an object of the present disclosure to provide a laser processing apparatus capable of suitably moving a condensing portion along a direction orthogonal to its optical axis.

### Solution to Problem

A laser processing apparatus according to one aspect of the present disclosure includes: a support portion configured to support a target and move along a first direction; a first moving portion configured to move along a second direction orthogonal to the first direction; a first attachment portion attached to the first moving portion and configured to move along a third direction orthogonal to the first direction and the second direction; a first laser processing head attached to the first attachment portion and configured to irradiate the target with a first laser light; a light source unit configured to output the first laser light; and a first mirror attached to the first moving portion and configured to reflect the first laser light. The first laser processing head includes a first entrance portion through which the first laser light enters and a first condensing portion configured to condense the first laser light and emit the first laser light. The light source unit includes a first emission portion configured to emit the first laser light. The first mirror is attached to the first moving portion to face the first emission portion in the second direction and face the first entrance portion in the third direction.

In this laser processing apparatus, the first condensing portion of the first laser processing head moves along a direction orthogonal to its optical axis, by moving the first moving portion to which the first laser processing head is attached via the first attachment portion along the second direction. Furthermore, the state where the first mirror faces the first emission portion of the light source unit in the second direction is maintained, even when the first moving portion moves along the second direction. Furthermore, the state where the first mirror faces the first entrance portion of the first laser processing head in the third direction is maintained, even when the first attachment portion moves along the third direction. Thus, the first laser light emitted from the first emission portion of the light source unit can reliably enter the first entrance portion of the first laser processing head, regardless of the position of the first laser processing head. Furthermore, a light source such as a high output ultrashort pulse laser, guiding for which using the optical fiber is otherwise difficult, can be used. The laser processing apparatus with the configuration described above is capable of suitably moving the condensing portion along the direction orthogonal to its optical axis.

In the laser processing apparatus according to one aspect of the present disclosure, the first mirror may be attached to the first moving portion to have at least one of an angle and a position adjustable. With this configuration, the first laser light emitted from the first emission portion of the light source unit can more reliably enter the first entrance portion of the first laser processing head.

In the laser processing apparatus according to one aspect of the present disclosure, the support portion may rotate about an axis parallel to the third direction. With this configuration, the target can be processed efficiently.

The laser processing apparatus according to one aspect of the present disclosure may further include: a second moving portion configured to move along the second direction; a second attachment portion attached to the second moving portion and configured to move along the third direction; and a second laser processing head attached to the second attachment portion and configured to irradiate the target with a second laser light, the light source unit may output the second laser light, the second laser processing head may include a second entrance portion through which the second laser light enters and a second condensing portion configured to condense the second laser light and emit the second laser light, and the light source unit may include a second emission portion configured to emit the second laser light. With this configuration, the second condensing portion of the second laser processing head moves along a direction orthogonal to its optical axis, by moving the second moving portion to which the second laser processing head is attached via the second attachment portion along the second direction. By providing a plurality of laser processing heads in this way, it is possible to efficiently process a target.

The laser processing apparatus according to one aspect of the present disclosure may further include a second mirror attached to the second moving portion and configured to reflect the second laser light, and the second mirror may be attached to the second moving portion to face the second emission portion in the second direction and face the second entrance portion in the third direction. With this configuration, the state where the second mirror faces the second emission portion of the light source unit in the second direction is maintained, even when the second moving portion moves along the second direction. Furthermore, the state where the second mirror faces the second entrance portion of the second laser processing head in the third direction is maintained, even when the second attachment portion moves along the third direction. Thus, the second laser light emitted from the second emission portion of the light source unit can reliably enter the second entrance portion of the second laser processing head, regardless of the position of the second laser processing head. Furthermore, a light source such as a high output ultrashort pulse laser, guiding for which using the optical fiber is otherwise difficult, can be used.

In the laser processing apparatus according to one aspect of the present disclosure, the second mirror may be attached to the second moving portion to have at least one of an angle and a position adjustable. With this configuration, the second laser light emitted from the second emission portion of the light source unit can more reliably enter the second entrance portion of the second laser processing head.

The laser processing apparatus according to one aspect of the present disclosure may further include an optical fiber through which the second laser light is guided from the second emission portion to the second entrance portion. With this configuration, the second laser light emitted from the second emission portion of the light source unit can more reliably enter the second entrance portion of the second laser processing head when the wavelength of the second laser light is a wavelength capable of being guided through the optical fiber.

### Advantageous Effects of Invention

According to the present disclosure, it is possible to provide a laser processing apparatus capable of suitably moving a condensing portion along a direction orthogonal to its optical axis.

### BRIEF DESCRIPTION OF DRAWINGS

FIG. 1 is a perspective view of a laser processing apparatus of an embodiment.

FIG. 2 is a front view of a portion of the laser processing apparatus illustrated in FIG. 1.

FIG. 3 is a front view of a laser processing head of the laser processing apparatus illustrated in FIG. 1.

FIG. 4 is a side view of the laser processing head illustrated in FIG. 3.

FIG. 5 is a diagram illustrating a configuration of an optical system of the laser processing head illustrated in FIG. 3.

FIG. 6 is a diagram illustrating a configuration of an optical system of a laser processing head of a modification example.

FIG. 7 is a front view of a portion of the laser processing apparatus of the modification example.

### DESCRIPTION OF EMBODIMENTS

Hereinafter, an embodiment of the present disclosure will be described in detail with reference to the drawings. The same elements in the figures will be denoted by the same reference signs, and overlapping descriptions will be omitted.

### Configuration of Laser Processing Apparatus

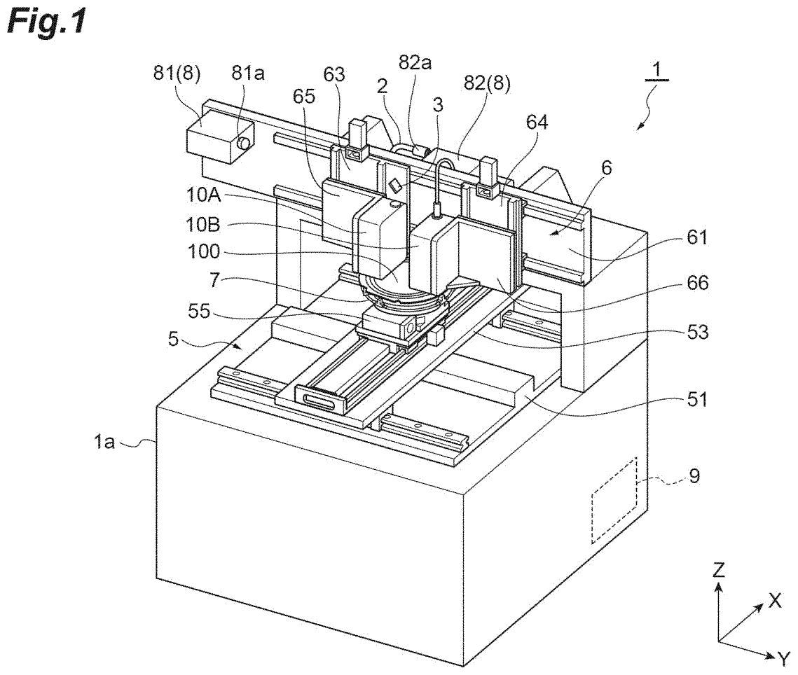

As illustrated in FIG. 1, a laser processing apparatus 1 includes a plurality of movement mechanisms 5 and 6, a support portion 7, a pair of laser processing heads 10A and 10B (a first laser processing head and a second laser processing head), a light source unit 8, and a controller 9. Hereinafter, a first direction is referred to as an X direction, a second direction orthogonal to the first direction is referred to as a Y direction, and a third direction orthogonal to the first direction and the second direction is referred to as a Z direction. In the present embodiment, the X direction and the Y direction are horizontal directions, and the Z direction is a vertical direction.

The movement mechanism 5 includes a fixed portion 51, a moving portion 53, and an attachment portion 55. The fixed portion 51 is attached to a device frame 1a. The moving portion 53 is attached to a rail provided on the fixed portion 51, and can move along the Y direction. The attachment portion 55 is attached to a rail provided on the moving portion 53, and can move along the X direction.

The movement mechanism 6 includes a fixed portion 61, a pair of moving portions (a first moving portion and a second moving portion) 63 and 64, and a pair of attachment portions (a first attachment portion and a second attachment portion) 65 and 66. The fixed portion 61 is attached to the device frame 1a. The pair of moving portions 63 and 64 are each attached to a rail provided on the fixed portion 61, and can each independently move along the Y direction. The attachment portion 65 is attached to a rail provided on the moving portion 63, and can move along the Z direction. The attachment portion 66 is attached to a rail provided on the moving portion 64, and can move along the Z direction. Thus, the pair of attachment portions 65 and 66 can respectively move along the Y direction and the Z direction relative to the device frame 1a.

The support portion 7 is attached to a rotation shaft provided to the attachment portion 55 of the movement mechanism 5, and can rotate about an axis parallel to the Z direction. Thus, the support portion 7 can move along each of the X direction and the Y direction, and can rotate about the axis parallel to the Z direction. The support portion 7 supports a target 100. The target 100 is, for example, a wafer.

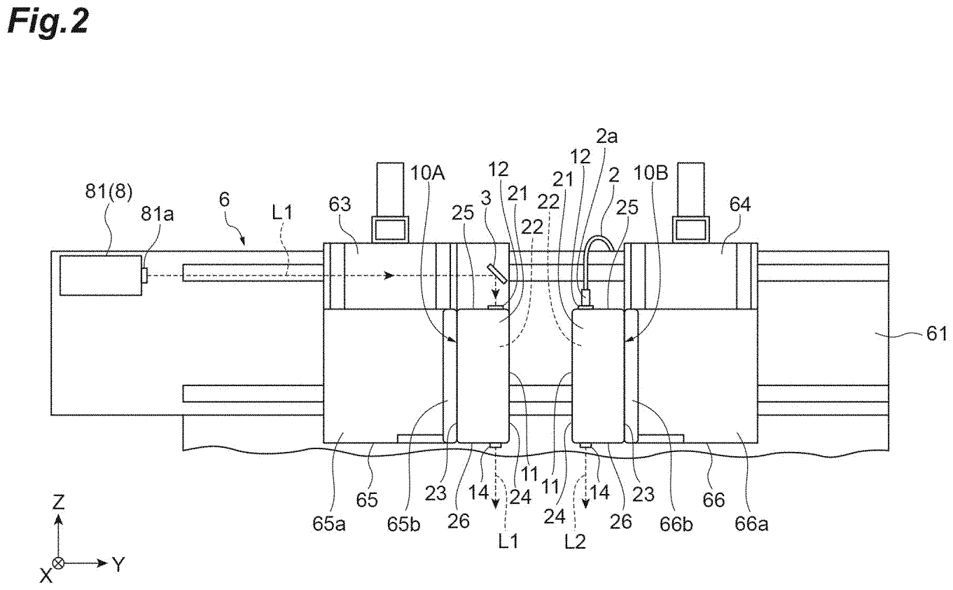

As illustrated in FIGS. 1 and 2, the laser processing head 10A is attached to the attachment portion 65 of the movement mechanism 6. The laser processing head 10A irradiates the target 100, supported by the support portion 7, with a laser light (first laser light) L1, while facing the support portion 7 in the Z direction. The laser processing head 10B is attached to the attachment portion 66 of the movement mechanism 6. The laser processing head 10B irradiates the target 100, supported by the support portion 7, with a laser light (second laser light) L2, while facing the support portion 7 in the Z direction.

The light source unit 8 includes a pair of light sources 81 and 82. The light source 81 is attached to the fixed portion 61 of the movement mechanism 6 The light source 81 outputs the laser light L1. The laser light L1 is emitted from an emission portion 81a (first emission portion) of the light source 81, and is guided to the laser processing head 10A by a mirror (first mirror) 3. A light source 82 is attached to the device frame 1a. The light source 82 outputs the laser light L2. The laser light L2 is emitted from an emission portion 82a (second emission portion) of the light source 82, and is guided to the laser processing head 10B by an optical fiber 2.

The configurations of the light source 81 and the mirror 3 will be described more in detail. The light source 81 is attached to the fixed portion 61 to be position on the side (side opposite to the moving portion 64) of the moving portion 63 in the Y direction. The emission portion 81a of the light source 81 faces toward the moving portion 63 side. The mirror 3 is attached to the moving portion 63 to face the emission portion 81a of the light source 81 in the Y direction and to face the entrance portion 12 of the laser processing head 10A in the Z direction. Furthermore, the mirror 3 is attached to the moving portion 63 to have at least one of angle and position adjustable. The laser light L1 emitted from the emission portion 81a of the light source 81 is reflected by the mirror 3 to enter through the entrance portion 12 of the laser processing head 10A. The light source 81 may be attached to the device frame 1a.

With the configuration described above, the state where the mirror 3 faces the emission portion 81a of the light source 81 in the Y direction is maintained, even when the moving portion 63 moves along the Y direction. Furthermore, the state where the mirror 3 faces the entrance portion 12 of the laser processing head 10A in the Z direction is maintained, even when the attachment portion 65 moves along the Z direction. Thus, the laser light L1 emitted from the emission portion 81a of the light source 81 enters the entrance portion 12 of the laser processing head 10A, regardless of the position of the laser processing head 10A.

The controller 9 controls each part of the laser processing apparatus 1 (such as the plurality of movement mechanisms 5 and 6, the pair of laser processing heads 10A and 10B, and the light source unit 8). The controller 9 is configured as a computer device including a processor, a memory, a storage, a communication device, and the like. In the controller 9, software (program) loaded onto the memory or the like is performed by the processor, and reading and writing of data from and to the memory and storage, and communication by the communication device are controlled by the processor. Thus, the controller 9 implements various functions.

An example of processing by the laser processing apparatus 1 configured as described above will be described. This example processing is an example in which a modified region is formed inside the target 100 along each of a plurality of lines set to form a grid pattern for cutting the target 100, which is a wafer, into a plurality of chips.

First of all, the movement mechanism 5 moves the support portion 7, supporting the target 100, along each of the X direction and the Y direction to make the support portion 7 face the pair of laser processing heads 10A and 10B in the Z direction. Then, the movement mechanism 5 rotates the support portion 7 about the axis parallel to the Z direction to align the plurality of lines extending in one direction on the target 100 with the X direction.

Subsequently, the movement mechanism 6 moves the laser processing head 10A along the Y direction to position the focusing point of the laser light L1 on one line extending in one direction. Furthermore, the movement mechanism 6 moves the laser processing head 10B along the Y direction to position the focusing point of the laser light L2 on another one of the lines extending in one direction. Then, the movement mechanism 6 moves the laser processing head 10A along the Z direction to position the focusing point of the laser light L1 inside the target 100. Furthermore, the movement mechanism 6 moves the laser processing head 10B along the Z direction to position the focusing point of the laser light L2 inside the target 100.

Then, the light source 81 outputs the laser light L1 and the laser processing head 10A irradiates the target 100 with the laser light L1, whereas the light source 82 outputs the laser light L2 and the laser processing head 10B irradiates the target 100 with the laser light L2. At the same time, the movement mechanism 5 moves the support portion 7 along the X direction to relatively move the focusing point of the laser light L1 along one line extending in one direction, and to relatively move the focusing point of the laser light L2 along another line extending in one direction. In this manner, the laser processing apparatus 1 forms the modified region inside the target 100 along each of the plurality of lines extending in one direction on the target 100.

Subsequently, the movement mechanism 5 rotates the support portion 7 about an axis parallel to the Z direction so that a plurality of lines extending in the other direction orthogonal to one direction of the target 100 are aligned with the X direction.

Subsequently, the movement mechanism 6 moves the laser processing head 10A along the Y direction to position the focusing point of the laser light L1 on one line extending in the other direction. On the other hand, the movement mechanism 6 moves the laser processing head 10B along the Y direction to position the focusing point of the laser light L2 on another line extending in the other direction. Then, the movement mechanism 6 moves the laser processing head 10A along the Z direction to position the focusing point of the laser light L1 inside the target 100. Furthermore, the movement mechanism 6 moves the laser processing head 10B along the Z direction to position the focusing point of the laser light L2 inside the target 100.

Then, the light source 81 outputs the laser light L1 and the laser processing head 10A irradiates the target 100 with the laser light L1, whereas the light source 82 outputs the laser light L2 and the laser processing head 10B irradiates the target 100 with the laser light L2. At the same time, the movement mechanism 5 moves the support portion 7 along the X direction to relatively move the focusing point of the laser light L1 along one extending in the other direction, and to relatively move the focusing point of the laser light L2 along another line extending in the other direction. In this manner, the laser processing apparatus 1 forms the modified region inside the target 100 along each of the plurality of lines extending in the other direction on the target 100 orthogonal to the one direction.

In one example processing described above, the light source 81 outputs the laser light L1 that transmits through the target 100 by pulse oscillation, and the light source 82 outputs the laser light L2 that transmits through the target 100 by pulse oscillation. When such laser lights are focused inside the target 100, the laser lights are mainly absorbed at the portion corresponding to the focusing points of the laser lights, whereby the modified region is formed inside the target 100. The modified region is a region in which the density, refractive index, mechanical strength, and other physical characteristics are different from those of the surrounding non-modified regions. Examples of the modified region include a melting treatment region, a crack region, a dielectric breakdown region, a refractive index change region, and the like.

When the target 100 is irradiated with the laser light output using the pulse oscillation and the focusing point of the laser light is relatively moved along the line set on the target 100, a plurality of modified spots are formed in an aligned manner along the line. One modified spot is formed by irradiation with one pulse laser light. A line of modified region is a collection of a plurality of modified spots aligned. Adjacent modified spots may be connected to each other or separated from each other depending on the relative moving speed of the focusing point of the laser light with respect to the target 100 and the repetition frequency of the laser light.

### Configuration of Laser Processing Head

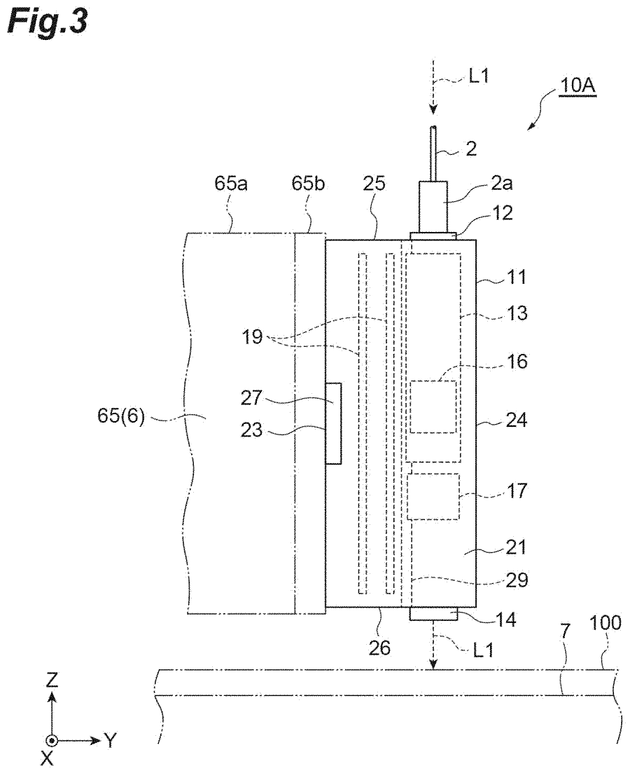

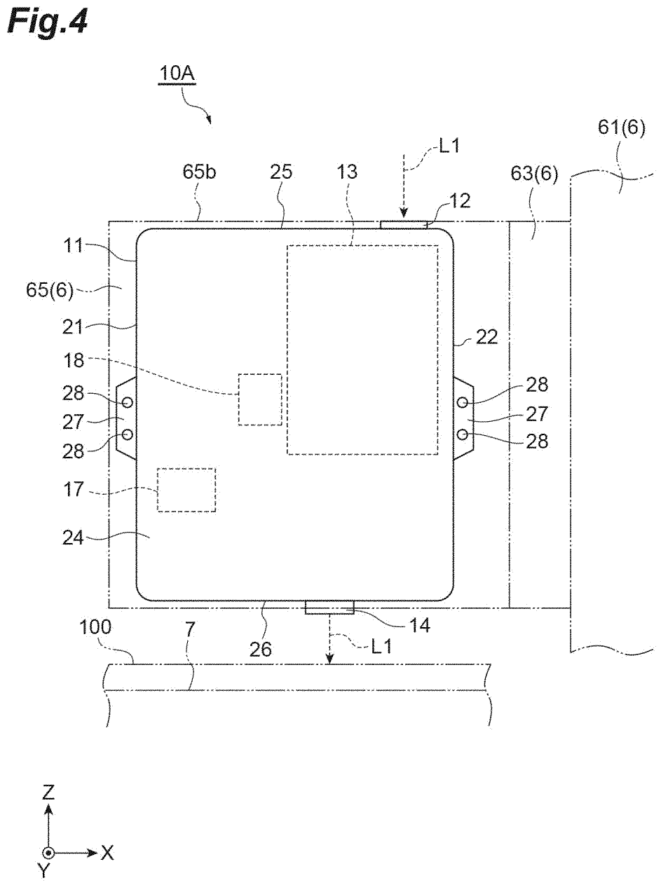

As illustrated in FIGS. 3 and 4, the laser processing head 10A includes a housing 11, an entrance portion (first entrance portion) 12, an adjustment portion 13, and a condensing portion (first condensing portion) 14.

The housing 11 has a first wall portion 21, a second wall portion 22, a third wall portion 23, a fourth wall portion 24, a fifth wall portion 25, and a sixth wall portion 26. The first wall portion 21 and the second wall portion 22 face each other in the X direction. The third wall portion 23 and the fourth wall portion 24 face each other in the Y direction. The fifth wall portion 25 and the sixth wall portion 26 face each other in the Z direction.

The distance between the third wall portion 23 and the fourth wall portion 24 is shorter than the distance between the first wall portion 21 and the second wall portion 22. The distance between the first wall portion 21 and the second wall portion 22 is shorter than the distance between the fifth wall portion 25 and the sixth wall portion 26. The distance between the first wall portion 21 and the second wall portion 22 may the same as the distance between the fifth wall portion 25 and the sixth wall portion 26, or may be longer than the distance between the fifth wall portion 25 and the sixth wall portion 26.

In the laser processing head 10A, the first wall portion 21 is located on the fixed portion 61 side of the movement mechanism 6, and the second wall portion 22 is located on side opposite to the fixed portion 61. The third wall portion 23 is located on the attachment portion 65 side of the movement mechanism 6, and the fourth wall portion 24 is located on the side opposite to the attachment portion 65 which is the laser processing head 10B side (see FIG. 2). The fifth wall portion 25 is located on the side opposite to the support portion 7, and the sixth wall portion 26 is located on the support portion 7 side.

The housing 11 is configured to be attached to the attachment portion 65, with the third wall portion 23 arranged on the attachment portion 65 side of the movement mechanism 6. The specific configuration is as follows. The attachment portion 65 includes a base plate 65a and an attachment plate 65b. The base plate 65a is attached to a rail provided on the moving portion 63 (see FIG. 2). The attachment plate 65b stands at an end portion of the base plate 65a on the laser processing head 10B side (see FIG. 2). The housing 11 is attached to the attachment portion 65 by screwing bolts 28 to the attachment plate 65b via supports 27 in a state where the third wall portion 23 is in contact with the attachment plate 65b. The supports 27 are respectively provided to the first wall portion 21 and the second wall portion 22. The housing 11 is detachably attached to the attachment portion 65.

The entrance portion 12 is attached to the fifth wall portion 25. The laser light L1 reflected by the mirror 3 enters the housing 11 through the entrance portion 12. The entrance portion 12 is offset toward the second wall portion 22 side (one wall portion side) in the X direction, and is offset toward the fourth wall portion 24 side in the Y direction. Specifically, the distance between the entrance portion 12 and the second wall portion 22 in the X direction is shorter than the distance between the entrance portion 12 and the first wall portion 21 in the X direction, and the distance between the entrance portion 12 and the fourth wall portion 24 in the Y direction is shorter than the distance between the entrance portion 12 and the third wall portion 23 in the X direction.

The adjustment portion 13 is arranged in the housing 11. The adjustment portion 13 adjusts the laser light L1 entered through the entrance portion 12. Each configuration of the adjustment portion 13 is attached to an optical base 29 provided in the housing 11. The optical base 29 is attached to the housing 11 so as to partition the area inside the housing 11 into a region on the third wall portion 23 side and a region on the fourth wall portion 24 side. The optical base 29 is integrated with the housing 11. Each configuration of the adjustment portion 13 is attached to the optical base 29 on the fourth wall portion 24 side. Details of the configurations of the adjustment portion 13 will be described later.

The condensing portion 14 is arranged in the sixth wall portion 26. Specifically, the condensing portion 14 is arranged in the sixth wall portion 26 while being inserted into a hole 26a formed in the sixth wall portion 26. The condensing portion 14 condenses the laser light L1 adjusted by the adjustment portion 13 and emits it to the outside of the housing 11. The condensing portion 14 is offset toward the second wall portion 22 (one wall portion side) in the X direction, and is offset toward the fourth wall portion 24 in the Y direction. Specifically, the distance between the condensing portion 14 and the second wall portion 22 in the X direction is shorter than the distance between the condensing portion 14 and the first wall portion 21 in the X direction, and the distance between the condensing portion 14 and the fourth wall portion 24 in the Y direction is shorter than the distance between the condensing portion 14 and the third wall portion 23 in the X direction.

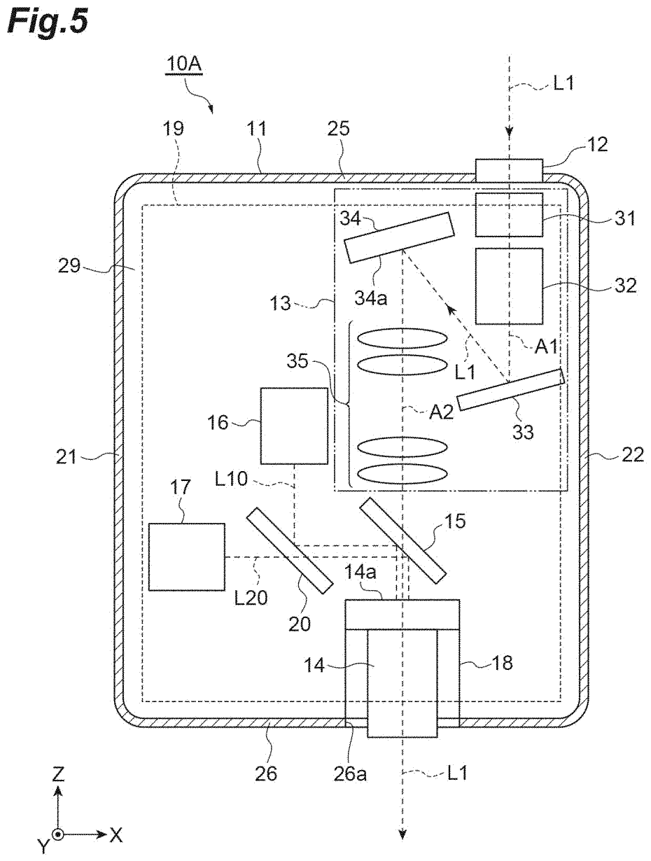

As illustrated in FIG. 5, the adjustment portion 13 includes an attenuator 31, a beam expander 32, and a mirror 33. The entrance portion 12, as well as the attenuator 31, the beam expander 32, and the mirror 33 of the adjustment portion 13 are arranged on a straight line (first straight line) A1 extending along the Z direction. The attenuator 31 and the beam expander 32 are arranged between the entrance portion 12 and the mirror 33 on the straight line A1. The attenuator 31 adjusts the output of the laser light L1 that has entered through the entrance portion 12. The beam expander 32 expands the diameter of the laser light L1 the output of which has been adjusted by the attenuator 31. The mirror 33 reflects the laser light L1 the diameter of which has been expanded by the beam expander 32.

The adjustment portion 13 further includes a reflective spatial light modulator 34 and an imaging optical system 35. The reflective spatial light modulator 34 and the imaging optical system 35 of the adjustment portion 13 as well as the condensing portion 14 are arranged on a straight line (second straight line) A2 extending along the Z direction. The reflective spatial light modulator 34 modulates the laser light L1 reflected by the mirror 33. The reflective spatial light modulator 34 is, for example, a spatial light modulator (SLM) of a reflective liquid crystal (Liquid Crystal on Silicon (LCOS)). The imaging optical system 35 serves as a bilateral telecentric optical system in which a reflecting surface 34a of the reflective spatial light modulator 34 and an entrance pupil surface 14a of the condensing portion 14 are in an imaging relationship. The imaging optical system 35 includes three or more lenses.

The straight line A1 and the straight line A2 are located on a plane orthogonal to the Y direction. The straight line A1 is located on the second wall portion 22 side (one wall portion side) with respect to the straight line A2. In the laser processing head 10A, the laser light L1 enters the housing 11 through the entrance portion 12, travels on the straight line A1, is sequentially reflected by the mirror 33 and the reflective spatial light modulator 34, and then travels on the straight line A2 to be emitted to the outside of the housing 11 through the condensing portion 14. The order of arrangement of the attenuator 31 and the beam expander 32 may be reversed. The attenuator 31 may be arranged between the mirror 33 and the reflective spatial light modulator 34. The adjustment portion 13 may further include other optical components (for example, a steering mirror arranged in front of the beam expander 32 or the like).

The laser processing head 10A further includes a dichroic mirror 15, a measurement portion 16, a monitoring portion 17, a driving portion 18, and a circuit portion 19.

The dichroic mirror 15 is arranged between the imaging optical system 35 and the condensing portion 14 on the straight line A2. That is, the dichroic mirror 15 is arranged between the adjustment portion 13 and the condensing portion 14 in the housing 11. The dichroic mirror 15 is attached to the optical base 29 on the fourth wall portion 24 side. The dichroic mirror 15 transmits the laser light L1. From the sake of suppressing astigmatism, the dichroic mirror 15 is preferably of, for example, a cube type or a two-plate type arranged in a twisted relationship.

The measurement portion 16 is arranged in the housing 11 on the first wall portion 21 side (opposite to one wall portion side) with respect to the adjustment portion 13. The measurement portion 16 is attached to the optical base 29 on the fourth wall portion 24 side. The measurement portion 16 outputs measurement light L10 for measuring the distance between the surface of the target 100 (for example, the surface on the side where the laser light L1 is incident) and the condensing portion 14, and detects the measurement light L10 reflected by the surface of the target 100 via the condensing portion 14. Thus, the surface of the target 100 is irradiated with the measurement light L10 output from the measurement portion 16, via the condensing portion 14, and then, the measurement light L10 reflected by the surface of the target 100 is detected by the measurement portion 16 via the condensing portion 14.

More specifically, the measurement light L10 output from the measurement portion 16 is sequentially reflected by a beam splitter 20 and the dichroic mirror 15 attached to the optical base 29 on the fourth wall portion 24 side, and then is emitted to the outside of the housing 11 from the condensing portion 14. The measurement light L10 reflected on the surface of the target 100 enters the housing 11 from the condensing portion 14 and is sequentially reflected by the dichroic mirror 15 and the beam splitter 20, to be incident on and detected by the measurement portion 16.

The monitoring portion 17 is arranged in the housing 11 on the first wall portion 21 side (opposite to one wall portion side) with respect to the adjustment portion 13. The monitoring portion 17 is attached to the optical base 29 on the fourth wall portion 24 side. The monitoring portion 17 outputs monitoring light L20 for monitoring the surface of the target 100 (for example, the surface on the side where the laser light L1 is incident), and detects the monitoring light L20 reflected by the surface of the target 100, via the condensing portion 14. Thus, the surface of the target 100 is irradiated with the monitoring light L20 output from the monitoring portion 17, via the condensing portion 14, and then, the monitoring light L20 reflected by the surface of the target 100 is detected by the monitoring portion 17 via the condensing portion 14.

More specifically, the monitoring light L20 output from the monitoring portion 17 transmits through the beam splitter 20 and is reflected by the dichroic mirror 15, to be emitted to the outside of the housing 11 from the condensing portion 14. The monitoring light L20 reflected by the surface of the target 100 enters the housing 11 through the condensing portion 14, and is reflected by the dichroic mirror 15 to be transmitted through the beam splitter 20 and to be incident on and detected by the monitoring portion 17. Wavelengths of the laser light L1, the measurement light L10, and the monitoring light L20 are different from each other (at least their center wavelengths are shifted from each other).

The driving portion 18 is attached to the optical base 29 on the fourth wall portion 24 side. The driving portion 18 moves the condensing portion 14, arranged on the sixth wall portion 26, along the Z direction using, for example, driving force of a piezoelectric element.

The circuit portion 19 is arranged on the third wall portion 23 side with respect to the optical base 29, in the housing 11. Specifically, in the housing 11, the circuit portion 19 is arranged on the third wall portion 23 side with respect to the adjustment portion 13, the measurement portion 16, and the monitoring portion 17. The circuit portion 19 is, for example, a plurality of circuit boards. The circuit portion 19 processes a signal output from the measurement portion 16 and a signal input to the reflective spatial light modulator 34. The circuit portion 19 controls the driving portion 18 based on the signal output from the measurement portion 16. As an example, the circuit portion 19 controls the driving portion 18 to maintain a constant distance between the surface of the target 100 and the condensing portion 14 (to maintain a constant distance between the surface of the target 100 and the focusing point of the laser light L1) based on the signal output from the measurement portion 16. The housing 11 is provided with a connector (not illustrated) to which wiring for electrically connecting the circuit portion 19 to the controller 9 (see FIG. 1) or the like is connected.

Similar to the laser processing head 10A, the laser processing head 10B includes the housing 11, the entrance portion (second entrance portion) 12, the adjustment portion 13, the condensing portion (second condensing portion) 14, the dichroic mirror 15, the measurement portion 16, the monitoring portion 17, the driving portion 18, and the circuit portion 19. Note that, as illustrated in FIG. 2, the configurations of the laser processing head 10B are in a plane-symmetrical relationship with the configurations of the laser processing head 10A, about a virtual plane that passes through the midpoint between the pair of attachment portions 65 and 66 and is orthogonal to the Y direction.

For example, the housing (first housing) 11 of the laser processing head 10A is attached to the attachment portion 65 with the fourth wall portion 24 positioned on the laser processing head 10B side with respect to the third wall portion 23, and with the sixth wall portion 26 positioned on the support portion 7 side with respect to the fifth wall portion 25. On the other hand, the housing (second housing) 11 of the laser processing head 10B is attached to the attachment portion 66 with the fourth wall portion 24 positioned on the laser processing head 10A side with respect to the third wall portion 23, and with the sixth wall portion 26 positioned on the support portion 7 side with respect to the fifth wall portion 25.

The housing 11 of the laser processing head 10B is configured to be attached to the attachment portion 66 with the third wall portion 23 arranged on the attachment portion 66 side. The specific configuration is as follows. The attachment portion 66 includes a base plate 66a and an attachment plate 66b. The base plate 66a is attached to a rail provided on the moving portion 63. The attachment plate 66b stands at an end portion of the base plate 66a on the laser processing head 10A side. The housing 11 of the laser processing head 10B is attached to the attachment portion 66 with the third wall portion 23 being in contact with the attachment plate 66b. The housing 11 of the laser processing head 10B is detachably attached to the attachment portion 66.

In the laser processing head 10B, the entrance portion 12 is configured to be connectable with a connection end portion 2a of the optical fiber 2. The connection end portion 2a of the optical fiber 2 is provided with a collimator lens that collimates the laser light L2 emitted from an emission end of the fiber, but is not provided with an isolator that suppresses the return light. The isolator is provided at an intermediate portion of the fiber more on the light source 82 side than the connection end portion 2a. This leads to downsizing of the connection end portion 2a, and of the entrance portion 12. The isolator may be provided at the connection end portion 2a of the optical fiber 2.

### Operation and Effect

In this laser processing apparatus 1, the condensing portion 14 of the laser processing head 10A moves along a direction orthogonal to its optical axis, by moving the moving portion 63 to which the laser processing head 10A is attached via the attachment portion 65 along the Y direction. Furthermore, the state where the mirror 3 faces the emission portion 81a of the light source 81 in the Y direction is maintained, even when the moving portion 63 moves along the Y direction. Furthermore, the state where the mirror 3 faces the entrance portion 12 of the laser processing head 10A in the Z direction is maintained, even when the attachment portion 65 moves along the Z direction. Thus, the laser light L1 emitted from the emission portion 81a of the light source 81 can reliably enter the entrance portion 12 of the laser processing head 10A, regardless of the position of the laser processing head 10A. Furthermore, a light source such as a high output ultrashort pulse laser, guiding for which using the optical fiber is otherwise difficult, can be used. The laser processing apparatus 1 with the configuration described above is capable of suitably moving the condensing portion 14 along the direction orthogonal to its optical axis.

Furthermore, in the laser processing apparatus 1, the mirror 3 is attached to the moving portion 63 to have at least one of angle and position adjustable. With this configuration, the laser light L1 emitted from the emission portion 81a of the light source 81 can reliably enter the entrance portion 12 of the laser processing head 10A.

In the laser processing apparatus 1, the support portion 7 rotates about the axis parallel to the Z direction. With this configuration, the target 100 can be processed efficiently.

In the laser processing apparatus 1, the light source unit 8 includes the emission portion 82a through which the laser light L2 is emitted, and the laser processing head 10B includes the entrance portion 12 through which the laser light L2 enters and the condensing portion 14 with which the laser light L2 is condensed and emitted. With this configuration, the condensing portion 14 of the laser processing head 10B moves along a direction orthogonal to its optical axis, by moving the moving portion 64 to which the laser processing head 10B is attached via the attachment portion 66 along the Y direction. By providing the plurality of laser processing heads 10A and 10B in this way, it is possible to efficiently process the target 100.

In the laser processing apparatus 1, the laser light L2 is guided to the laser processing head 10B through the optical fiber 2. With this configuration, the laser light L2 emitted from the emission portion 82a of the light source unit 8 can more reliably enter the entrance portion 12 of the laser processing head 10B when the wavelength of the laser light L2 is a wavelength capable of being guided through the optical fiber 2.

### MODIFICATION EXAMPLES

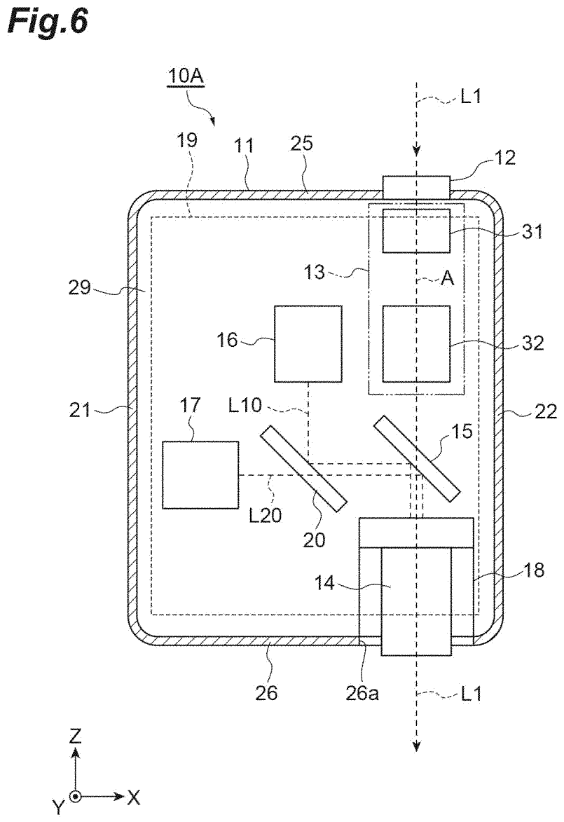

The present disclosure is not limited to the embodiment described above. For example, as illustrated in FIG. 6, the entrance portion 12, the adjustment portion 13, and the condensing portion 14 may be arranged on a straight line A extending along the Z direction. With this configuration, the adjustment portion 13 can be configured compactly. In this case, the adjustment portion 13 may not include the reflective spatial light modulator 34 and the imaging optical system 35. Further, the adjustment portion 13 may include the attenuator 31 and the beam expander 32. With this configuration, the adjustment portion 13 including the attenuator 31 and the beam expander 32 can be compactly configured. The order of arrangement of the attenuator 31 and the beam expander 32 may be reversed.

The housing 11 may have any configuration to be attached to the attachment portion 65 (or the attachment portion 66) with at least one of the first wall portion 21, the second wall portion 22, the third wall portion 23, and the fifth wall portion 25 arranged on the attachment portion 65 (or the attachment portion 66) side of the laser processing apparatus 1. The condensing portion 14 may have any configuration as long as it is at least offset toward the fourth wall portion 24 in the Y direction. With such configurations, when the housing 11 moves along the Y direction, for example, even if another configuration exists on the fourth wall portion 24 side, the condensing portion 14 can be brought near the other configuration. When the housing 11 moves along the Z direction, the condensing portion 14 can be brought close to the target 100, for example.

The condensing portion 14 may be offset toward the first wall portion 21 in the X direction. With this configuration, when the housing 11 moves along a direction orthogonal to the optical axis of the condensing portion 14, even if another configuration exists on the first wall portion 21 side, for example, the condensing portion 14 can be brought near the other configuration. In this case, the entrance portion 12 may be offset toward the first wall portion 21 in the X direction. With this configuration, another configuration (the measurement portion 16 and the monitoring portion 17 for example) can be arranged in a region, of a region in the housing 11, on the second wall portion 22 side with respect to the adjustment portion 13, or such a region can be used for the other like purposes. Thus, the region can be effectively used.

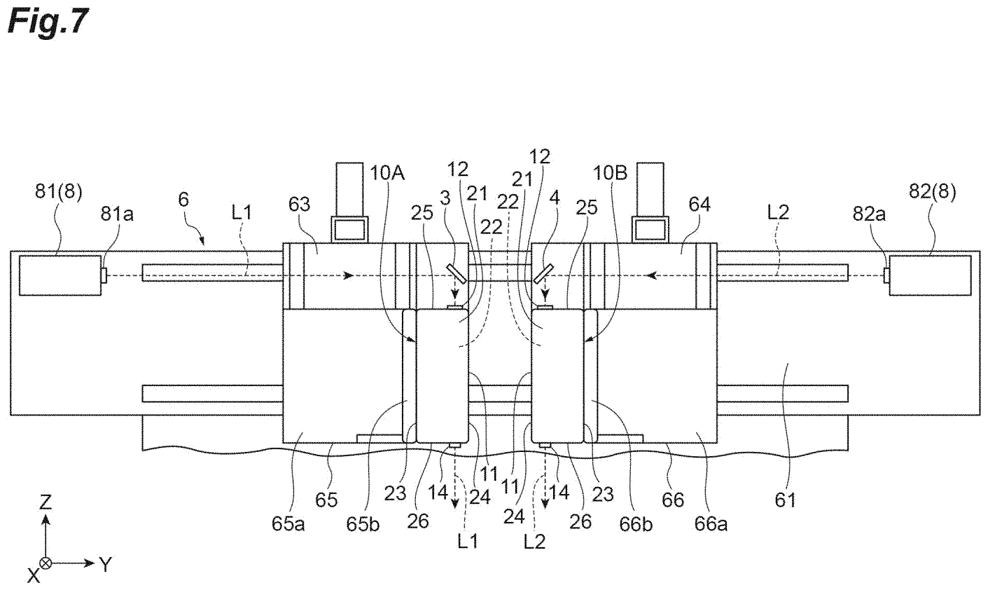

Further, the guiding of the laser light L1 from the emission portion 81a of the light source 81 to the entrance portion 12 of the laser processing head 10A and guiding of the laser light L2 from the emission portion 82a of the light source 82 to the entrance portion 12 of the laser processing head 10B may also be implemented by a mirror. FIG. 7 is a front view of the laser processing apparatus 1 in which not only the laser light L1 but also the laser light L2 is guided by the mirror. The configuration illustrated in FIG. 7 will be described below.

The light source 82 is attached to the fixed portion 61 to be position on the side (side opposite to the moving portion 63) of the moving portion 64 in the Y direction. The emission portion 82a of the light source 82 faces toward the moving portion 64 side. The mirror (second mirror) 4 is attached to the moving portion 64 to face the emission portion 82a of the light source 82 in the Y direction and to face the entrance portion 12 of the laser processing head 10B in the Z direction. Furthermore, the mirror 4 is attached to the moving portion 64 to have at least one of angle and position adjustable. The laser light L2 emitted from the emission portion 82a of the light source 82 is reflected by the mirror 4 to enter through the entrance portion 12 of the laser processing head 10B. The light source 82 may be attached to the device frame 1a.

With the configuration described above, the state where the mirror 4 faces the emission portion 82a of the light source 82 in the Y direction is maintained, even when the moving portion 64 moves along the Y direction. Furthermore, the state where the mirror 4 faces the entrance portion 12 of the laser processing head 10B in the Z direction is maintained, even when the attachment portion 66 moves along the Z direction. Thus, the laser light L2 emitted from the emission portion 82a of the light source 82 enters the entrance portion 12 of the laser processing head 10B, regardless of the position of the laser processing head 10B. Thus, the laser light L2 emitted from the emission portion 82a of the light source 82 can reliably enter the entrance portion 12 of the laser processing head 10B, regardless of the position of the laser processing head 10B. Furthermore, a light source such as a high output ultrashort pulse laser, guiding for which using the optical fiber is otherwise difficult, can be used.

Furthermore, with the configuration illustrated in FIG. 7, the mirror 4 may be attached to the moving portion 64 to have at least one of angle and position adjustable. With this configuration, the laser light L2 emitted from the emission portion 82a of the light source 82 can reliably enter the entrance portion 12 of the laser processing head 10B.

Furthermore, the light source unit 8 may include a single light source. In this case, the light source unit 8 may be configured to emit a part of a laser light, output from one light source, from the emission portion 81a and emit the remaining part of the laser light from an emission portion 82a.

The laser processing apparatus 1 may include one set or three or more sets of the combination including the moving portion, the attachment portion attached to the moving portion, the laser processing head attached to the attachment portion, and the mirror attached to the moving portion.

The laser processing head and the laser processing apparatus of the present disclosure are not limited to those for forming the modified region in the target 100, and thus may be those for implementing other types of laser processing.

Finally, an example of an operation performed by the laser processing apparatus 1 will be described. An example of the operation performed by the laser processing apparatus 1 is as follows. It is assumed that a plurality of lines extending in the X direction and arranged in the Y direction are set to the target 100. In such a state, the controller 9 performs a first scan process of scanning a single line with the laser light L1 in the X direction, and a second scan process of scanning another line with the laser light L2 in the X direction. The first scan process and the second scan process at least partially overlap in time. Particularly, the controller 9 can perform, while performing the first scan process one by one on the lines from the one positioned in one end portion of target 100 in the Y direction toward the line one the inner side in the Y direction, the second scan process one by one on the lines from the one positioned in the other end position of the target 100 in the Y direction toward the one on the inner side in the Y direction. As a result, the throughput can be improved.

An example of the operation performed by the laser processing apparatus 1 is as follows. In the laser processing apparatus 1, the controller 9 performs a first scan process in a first state where the laser processing heads 10A and 10B are arranged on one line, to scan the one line with the laser light L1 in the X direction with the focusing point of the laser light L1 positioned at a first position in the Z direction, and performs a second scan process in the first state to scan the one line with the laser light L2 in the X direction with the focusing point of the laser light L2 positioned at a second position (a position more on the incident surface side than the first position) in the Z direction. The controller 9 performs the first scan process and the second scan process with the focusing point of the laser light L2 positioned to be separated from the focusing point of the laser light L1 toward the direction opposite to the X direction by a predetermined distance. The predetermined distance is, for example, 300 μm. With this configuration, cracks can sufficiently advance from the modified region, while improving the throughput.

An example of the operation performed by the laser processing apparatus 1 is as follows. The controller 9 performs the first scan process of scanning one line with the laser light L1 in the X direction and the second scan process of scanning another line with the laser light L2 in the X direction, with the scan processes at least partially overlapping in time, and performs an image capturing process of capturing an image of a region of the target 100 including a line on which the processing has been completed, using an imaging unit movable together with the laser processing head 10A, while only the second scan process is being performed. In the image capturing process, light (light in a near infrared region for example) transmitting through the target 100 is used. With this configuration, whether the laser processing has been successfully performed can be checked in a non-destructive manner, using a time during which the first scan process is not performed.

An example of the operation performed by the laser processing apparatus 1 is as follows. The laser processing apparatus 1 performs peeling processing of peeling a part of the target 100. For example, in the peeling processing, while the support portion 7 rotates, the laser processing heads 10A and 10B respectively emit the laser lights L1 and L2, and the movement of each of the focusing points of the laser lights L1 and L2 in the horizontal direction is controlled. Thus, the modified region is formed along a virtual plane in the target 100. As a result, a part of the target 100 can be peeled with the modified region over the virtual plane serving as a boundary.

An example of the operation performed by the laser processing apparatus 1 is as follows. The laser processing apparatus 1 performs trimming processing of removing an unnecessary portion of the target 100. For example, in the trimming processing, while the support portion 7 rotates, starting and stopping of the emission of the laser lights L1 and L2 from the laser processing heads 10A and 10B is controlled based on rotation information on the support portion 7, in a state where the focusing point is position at positions along the circumferential edge of the effective region of the target 100. Thus, the modified region is formed along the circumferential edge of the effective region of the target 100. As a result, the unnecessary portion can be removed using a jig or air for example, with the modified region serving as a boundary.

An example of the operation performed by the laser processing apparatus 1 is as follows. For the target 100 having a functional element layer on the front surface side, the functional element layer is irradiated with the laser light L1 along a line from the back surface of the target 100, whereby a weakened region is formed in the functional element layer along the line. The laser light L2 with a pulse width shorter than the pulse width of the laser light L1 is emitted into the target 100 along the line from the back surface of the target 100, to follow the laser light L1. With the laser light L2 thus emitted, the crack reaching the front surface of the target 100 is reliably formed along the line, by utilizing the weakened region.

### REFERENCE SIGNS LIST

1 laser processing apparatus
2 optical fiber
3 mirror (first mirror)
4 mirror (second mirror)
7 support portion
8 light source unit
10A, 10B laser processing head (first laser processing head, second laser processing head)
12 entrance portion (first entrance portion, second entrance portion)
14 condensing portion (first condensing portion, second condensing portion)
63, 64 moving portion (first moving portion, second moving portion)
65, 66 attachment portion (first attachment portion, second attachment portion)
81a, 82a emission portion (first emission portion, second emission portion)

1. A laser processing apparatus comprising:
a support portion configured to support a target and move along a first direction;
a first moving portion configured to move along a second direction orthogonal to the first direction;
a first attachment portion attached to the first moving portion and configured to move along a third direction orthogonal to the first direction and the second direction;
a first laser processing head attached to the first attachment portion and configured to irradiate the target with a first laser light;
a light source unit configured to output the first laser light; and
a first mirror attached to the first moving portion and configured to reflect the first laser light, wherein
the first laser processing head includes a first entrance portion through which the first laser light enters and a first condensing portion configured to condense the first laser light and emit the first laser light,
the light source unit includes a first emission portion configured to emit the first laser light, and
the first mirror is attached to the first moving portion to face the first emission portion in the second direction and face the first entrance portion in the third direction.

2. The laser processing apparatus according to claim 1, wherein the first mirror is attached to the first moving portion to have at least one of an angle and a position adjustable.

3. The laser processing apparatus according to claim 1, wherein the support portion rotates about an axis parallel to the third direction.

4. The laser processing apparatus according to claim 1 further comprising:
a second moving portion configured to move along the second direction;
a second attachment portion attached to the second moving portion and configured to move along the third direction; and
a second laser processing head attached to the second attachment portion and configured to irradiate the target with a second laser light, wherein
the light source unit outputs the second laser light,
the second laser processing head includes a second entrance portion through which the second laser light enters and a second condensing portion configured to condense the second laser light and emit the second laser light, and
the light source unit includes a second emission portion configured to emit the second laser light.

5. The laser processing apparatus according to claim 4 further comprising a second mirror attached to the second moving portion and configured to reflect the second laser light, wherein
the second mirror is attached to the second moving portion to face the second emission portion in the second direction and face the second entrance portion in the third direction.

6. The laser processing apparatus according to claim 5, wherein the second mirror is attached to the second moving portion to have at least one of an angle and a position adjustable.

7. The laser processing apparatus according to claim 4 further comprising an optical fiber through which the second laser light is guided from the second emission portion to the second entrance portion.
